(19) United States
(12) Patent Application Publication
(10) Pub. No.: US 2013/0326973 A1
(43) Pub. Date: Dec. 12, 2013

(54) WINDOW RAIN GUARD & WIND DEFLECTOR

(71) Applicant: Steven D. RIVERA, Kapa'au, HI (US)

(72) Inventor: Steven D. RIVERA, Kapa'au, HI (US)

(21) Appl. No.: 13/492,822

(22) Filed: Jun. 9, 2012

(51) Int. Cl. E06B 3/26

(52) U.S. Cl. 52/202

(57) ABSTRACT

A rain guard and wind deflector device employs a flat panel of transparent plastic material installed by its mounting edge and adjoining opposing linear sides to corresponding linear sides of a window frame or window trim. The flat panel has a width to its free end extending over a substantial portion of the width of a window pane slidable on an inner track for opening the window. The flat panel leaves a small gap distance from the typical window screen in an outer track space of the window frame to allow air ventilation under rainy or windy conditions, while deterring dampness or dust passing into the interior of the house. A preferred plastic material is polymethyl methacrylate (PMMA). The flat panel can be preformed in standard sizes or cut to size and installed directly on the window frame or window trim without special tools and using common types of fasteners.

### TECHNICAL FIELD

This U.S. Patent Application relates to a window rain guard and wind deflector device, and particularly to one that can be easily and conveniently installed as an add-on or retrofit to commonly sold, prefabricated household windows.

### BACKGROUND OF INVENTION

Prefabricated household window units are commonly sold for installation in new construction, remodeling, or replacement of windows in homes. Such prefabricated units are available to the home construction industry and sold in construction supply stores under well-known brand names such as Andersen™, Jeld-Wen™, Milgard™, and Simpson™ windows. They are typically manufactured in a range of standard sizes, and are designed and fabricated with cost-effective materials for optimum weather and wear-resistance, air-flow, reduced energy consumption, and aesthetic quality. Prefabricated units are available in many functional types, such as double or single-hung, sliding, awning, and more.

Sliding window units are widely used to maximize external views in wall spaces of substantial lengths. A typical sliding window unit is installed lengthwise in a wall space and has a pair of side-by-side glass window pane units, one or both of which can slide laterally in a track or tracks formed in the window frame. The glass pane units may be tinted or treated with thermal or optical films. In single-pane sliding window units, an inner glass pane is laterally slidable from one lateral half side on an inner track (on the inside of the house wall) in parallel behind a fixed outer pane positioned on the other lateral half side in an outer track space. An insect screen is spring-mounted in the outer track space on the first lateral half side adjoining the fixed pane. When the inner pane is slid laterally to open the window, air ventilation can flow in and out of the open side through the insect screen. In double-pane sliding window units, both inner and outer glass panes are laterally slidable from their respective lateral half sides on respective tracks, and a double-width insect screen is mounted in an external frame space on an outer side of the two glass pane tracks. Window pane locks may be provided to lock an open pane in a partially opened position, so that the window can be left open for ventilation while preventing the pane from being further opened from the outside to deter unauthorized entry.

A common occurrence in homes is that windows may be opened to let in air ventilation and light, and then left open, perhaps locked in a partially opened position, while the home occupants are elsewhere inside the house or leave the house unattended. If it rains while the windows are left partially opened, rain droplets can be swept through the screen and dampen or soak the window sills, rugs, curtains, and other furnishings inside the house. Rain damage buildup can lead to costly repairs, stagnant moisture in furnishings, and mold growth. In locations that have strong winds, sudden wind storms can arise and blow dust and debris through partially opened windows to contaminate the interior of the home.

In past times, window shutters have been installed on the outside of windows to deflect rain or wind while the windows are left open for ventilation. The shutters are typically hinged to the outside of the window frame and provided with downwardly inclined slats to allow air to pass under the slats while deflecting rain or wind from above or from the side. However, window shutters are a costly addition to the costs of installing windows, and require constant maintenance. For contemporary home designs, the addition of outer shutters can obscure views from within the house, and are not favored for a contemporary look as compared to the openness of all-glass-pane windows.

Various types of rain guards and wind shades have been proposed for use with prefabricated window units. One example shown in U.S. Pat. No. 4,899,646 to Maras provides a triple-track double-hung storm window in which a rain guard of transparent plastic material has sealed top and side edges mounted in an outer window track, and a rectangular hollow body with an open lower aperture for allowing air to pass upwardly and through an opened window while deflecting rain and wind from above or from the side. Another example shown in U.S. Pat. No. 7,165,596 to Helton employs a transparent plastic unit with an outwardly angled front panel supported on right-triangular side panels that can be retrofitted to a double hung window by hook-and-loop fasteners, magnetic tape (to metal windows) or a channel preformed on an outer window sash of the double-hung unit receiving an upper mounting lip of the rain guard. These prior devices have a bulging or projecting deflector body which obscures the aesthetic appearance of the window. In the case of the Maras triple-track window, and optionally in the case of the Helton outer sash channel mounting, the mounting for the rain guard must be preformed with the manufacture of the window, which precludes convenient add-on or retrofit mounting of the rain guard to standard prefabricated window units.

### SUMMARY OF INVENTION

It is a principal object of the present invention to provide a window rain guard and wind deflector device that can be easily and conveniently installed as an add-on or retrofit to commonly sold, prefabricated household windows without requiring the need for preformed manufacture. A further object is to provide a transparent appearance when the device is installed that does not obscure the aesthetic appearance of the window. Yet a further object is to provide a device that can be readily sized and installed for a wide range of types and sizes of windows without the need for preformed manufacture.

In accordance with the present invention, a rain guard and wind deflector device is provided for use with a prefabricated window of the type having at least one window pane of a predetermined length and width thereof that is slidable on one lateral side in an inner track of a rectangular-shaped window structure. Typically, an insect screen is mounted in an outer track space of the window structure. The device has a flat panel of transparent plastic material in a rectangular shape which is defined by a mounting edge on one linear side of the rectangular shape. First fastener means holds the mounting edge of the flat panel to a corresponding linear side of the window structure. Second and third fastener means similarly hold opposing linear sides adjoining the mounting edge of the flat panel to opposing linear sides adjoining the one linear side of the window structure, respectively. The mounting edge of the flat panel has a length slightly greater than the length of the one linear side of the slidable window pane and a width in a direction that the window pane is slid that is a substantial portion of the width of the window pane. The outer surfaces of the linear sides of the window structure extend outwardly a slight gap distance beyond the insect screen mounted in the outer track space in the window structure. This leaves the slight gap distance between the flat panel and the insect screen for air-flow through the window when the window pane is slid to an opened position.

In one preferred embodiment, the rain guard and wind deflector device may be used with a single-pane sliding window unit of the type having an inner glass pane slidable in parallel with a fixed outer glass pane positioned in an outer track space. The fastener means on three sides are attachable to hold the mounting edge and adjoining opposing linear sides of the flat panel to the corresponding linear sides of the window frame.

In another preferred embodiment, the rain guard and wind deflector device may be used with a single-pane or double-pane sliding window unit which has glass panes mounted within the window frame, and around which a window trim in a rectangular shape having linear sides to be installed surrounding corresponding linear sides of the window frame. The fastener means on three sides are attachable to hold the mounting edge and adjoining opposing linear sides of the panel to the linear sides of the window trim.

In one preferred version, the flat panel may have a bead along its mounting edge for alignment with the linear side of the window frame or trim, and to protect the joint between the panel and window frame or trim from rain or debris. In another preferred version, the flat panel may be configured with a curved bend radius proximate the mounting edge and adjoining opposing linear sides to form a flat panel surface that is raised a slight gap distance beyond the plane of the linear sides of the flat panel. The raised panel surface may be used to provide a greater air gap with the screen in the outermost space of the window structure.

A preferred transparent plastic material for the flat panel is polymethyl methacrylate (PMMA) or methyl methacrylate resin, which was first commercially available under the brand name PLEXIGLAS™ for plastic sheeting sold by Rohm and Haas Company. The plastic sheeting may have a preferred thickness for rain guard application in the range of 1/16 inch to ¼ inch thick, or more preferably ⅛ inch to 3/16 inch thick.

A preferred type of fastener means is double-sided sticky adhesive tape which is commonly available and can be readily cut to correct length and applied to form an adhesive layer between the linear sides of the flat panel and the corresponding sides of the window frame or trim. Other types of suitable fastener means may be used, such as hook-and-loop fastener strips or magnetic strips for metal-framed windows. The fastener means should have sufficient holding strength to be stable under expected high rain and wind forces, but low enough that the flat panel can be forced outwards from the inside for emergency exit through the open window.

In still another embodiment, a rain guard and wind deflector device may be adapted for use with a window unit having a window frame surrounded by corresponding linear sides of window trim, and the fastener means are mounting means attachable to the linear sides of the window trim and provided with tabs to hold the flat panel to the window frame. A preferred type of mounting means is a commonly available screen clip which has a screw mounting for mounting into window trim and a swivel tab which can be swiveled in position to hold the sides of the flat panel to the window frame.

The rain guard and wind deflector device may be used as an add-on or retrofit to any type and size of prefabricated windows. Most preferably, it may be used for sliding window units having frames made of vinyl or metal with smooth external surfaces for adhesive attachment of the flat panel. A preferred width for the flat panel may be in the range of at least 4 inches, to overlap a standard 3 inch distance of the security locked position for sliding window panes, and up to about 12 inches, depending on the size of the openable window panes. Most preferably, the flat panel has a width of 6 to 8 inches. The flat panel length may be preformed in standard lengths or cut to the window frame size that the flat panel is to have its mounting edge attached to. Most preferably, the flat panel lengths may preformed or cut to size to accommodate sliding window frame heights of about 2 feet to 6 feet.

The rain guard and wind deflector device may also be adapted for use with single-hung windows having a mid-frame segment for a fixed upper pane to which the mounting edge of the flat panel may be attached and the flat panel oriented to extend downwardly over a slidable lower pane for deflecting rain and wind when the lower pane is opened.

In another preferred version, the flat panel has a bead formed along its mounting edge which projects a small distance in a direction normal to the plane of the flat panel. The bead forms an alignment surface for abutting the linear side edge of the window frame or trim, so that the flat panel can be readily aligned in correct position to the window frame or trim. When using double-sided sticky adhesive tape, the bead covers the adhesive joint between the mounting edge of the flat panel and the linear side of the window frame or trim to prevent rain, dirt, or moisture from degrading the adhesive joint.

The flat panel may also have reinforcing strips attached on the edges of the adjoining opposing linear sides of the panel to stiffen the plane of the panel and its free end from deflection in strong winds. The reinforcing strips may be made of the same plastic material or, if needed, a stiffer plastic material.

Other objects, features, and advantages of the present invention will be explained in the following detailed description of the invention having reference to the appended drawings.

### BRIEF DESCRIPTION OF DRAWINGS

FIG. 1 shows a preferred embodiment of a rain guard and wind deflector device adapted to be fastened to the window frame of a sliding window unit.

FIG. 2 shows the rain guard and wind deflector device adapted to be fastened to the window trim around a sliding window unit.

FIG. 3A shows a side sectional view of the rain guard and wind deflector device fastened to the window frame, and FIG. 3B shows it fastened to the window trim.

FIG. 4 shows another preferred embodiment of the rain guard and wind deflector device in which the flat panel has a curved bend radius proximate its linear sides to form a raised panel surface for a greater gap distance for air flow through an opened window.

FIGS. 5A, 5B, and 5C show the flat panel with raised panel surface in front, side, and top views, respectively.

FIGS. 6A, 6B, 6C and 6D show another preferred version of the flat panel in front, side, top and enlarged assembled views, respectively.

FIGS. 7A, 7B, 7C and 7D show yet another preferred version of the flat panel in front, side, top and perspective views, respectively.

FIG. 8 shows the flat panel mounted using screen clips fastened to the window trim to hold it to the window frame.

FIG. 9 shows the screen clip mounting in greater detail.

FIG. 10 shows the rain guard and wind deflector device adapted for use with single-hung window units.

### DESCRIPTION OF PREFERRED EMBODIMENTS

In the following detailed description of the invention, certain preferred embodiments are illustrated providing certain specific details of their implementation. However, it will be recognized by one skilled in the art that many other variations and modifications may be made given the disclosed principles of the invention.

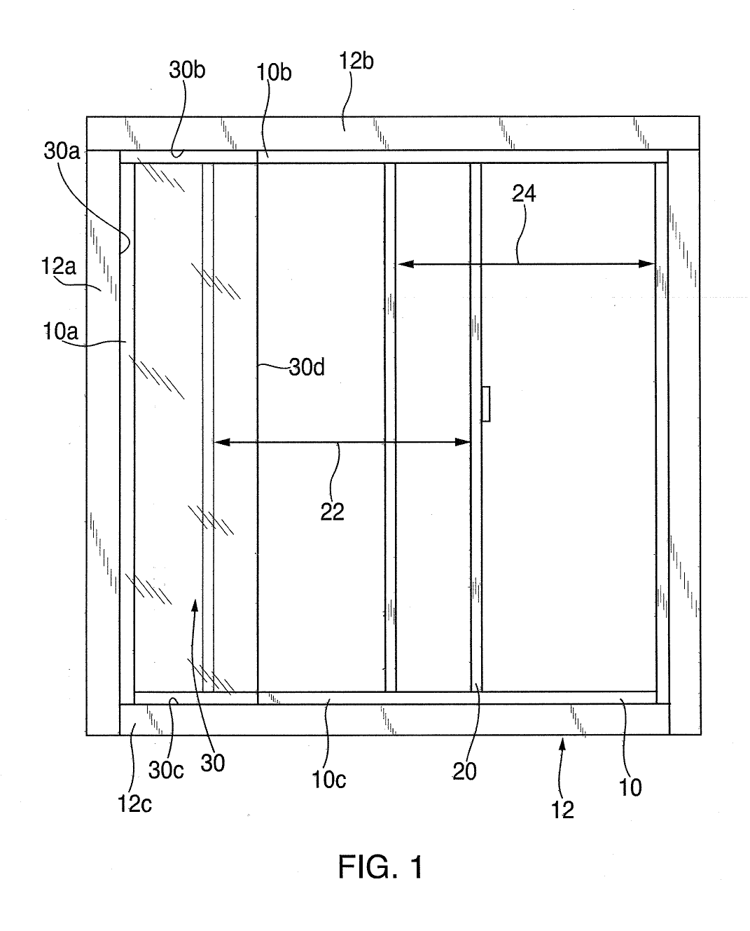

Referring to FIG. 1, a preferred embodiment of a rain guard and wind deflector device in accordance with the present invention is adapted for use with a prefabricated window unit such as the sliding window unit shown. The sliding window unit has a window frame 10 in a rectangular shape with linear sides. Window or molding trim 12 with corresponding linear sides may be installed surrounding the linear sides of the window frame 10. At least one slidable window pane 20 is ranged to be slidable on one lateral side (left side in the figure) to an opened position 22 in an inner track 23 (not shown in the figure) of the window structure. In a single sliding window unit, an opposite window pane 24 is fixed in position on an opposite lateral side (right side in the figure) in an outer track space 25 (not shown in the figure) of the window structure. Typically, an insect screen 26 (transparent in the figure) is mounted on the one lateral side in the outer track space adjoining the fixed window pane 24. In a double sliding window unit, the other window pane 24 is slidable in an outer track of the window structure, and a double-width insect screen is positioned in an outermost track space spanning both lateral sides of the window structure.

The rain guard and wind deflector device in accordance with the present invention has a flat panel 30 of a rectangular shape made of transparent plastic material (shown with cross-hatched shade lines in the figure) that is fastened to the linear sides 10a, 10b, 10c of the window frame 10 or linear sides 12a, 12b, 12c of the window trim 12. The flat panel 30 is defined with a mounting edge 30a on one linear side of its rectangular shape, adjoining opposing linear sides 30b, 30c, and a free end 30d. The flat panel has a width that extends a substantial part of the opening width in the direction the window pane slides to deflect rain and wind from entering the interior while the siding window pane is open. The outer surfaces of the linear sides 10a, 10b, 10c of the window frame 10 extend outwardly a slight gap distance, typically ¼ inch or more, beyond the insect screen mounted in the outer track space in the window frame. Thus, the gap distance of at least ¼ inch is left between the flat panel 30 mounted to the window frame 10 and the insect screen for air-flow through the window when the window pane 20 is slid to an opened position 22.

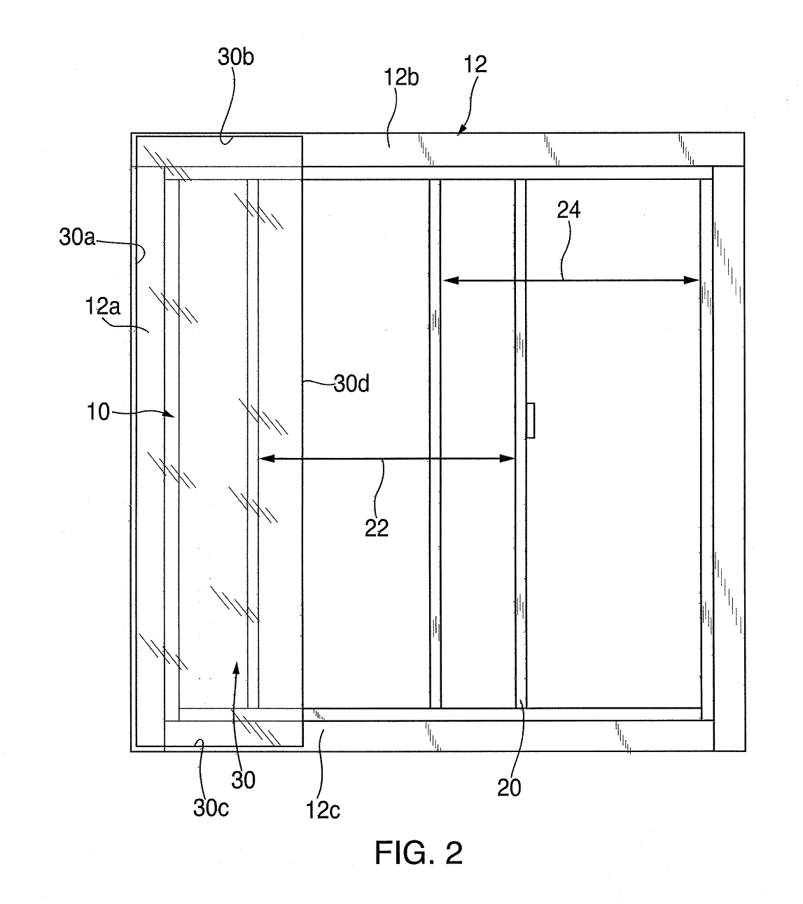

FIG. 2 shows another version in which the rain guard and wind deflector device with flat panel 30 is installed over and fastened to linear sides 12a, 12b, 12c of the window trim 12. The outer surfaces of the window trim typically extend outwardly beyond the window frame 10, typically ⅛ inch or more. Thus, a gap distance of at least ⅜ inch or more may be left between the flat panel 30 mounted to the window trim 12 and the insect screen for air-flow through the window when the window pane 20 is slid to an opened position 22.

The installation in FIGS. 1 and 2 is depicted in proportions for a 3 foot by 3 foot sliding glass window unit using an 8 inch wide flat panel. The flat panel may be preformed in the standard size or cut to the appropriate length at the installation site.

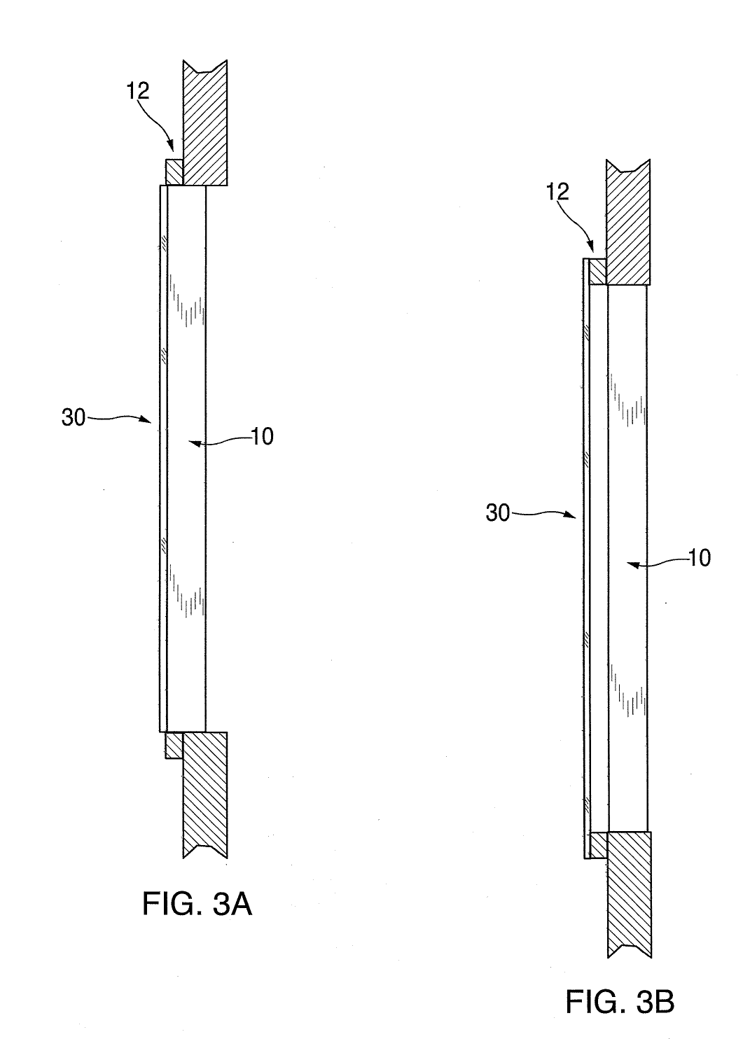

FIG. 3A shows a side sectional view of the rain guard and wind deflector device having the flat panel 30 fastened to the window frame 10, as depicted in FIG. 1. In the situation depicted, the window unit encasement has a frame 10 which has an outer projecting height greater than the window trim 12, so the flat panel is installed on the window frame. In the situation depicted in FIG. 3B, the window frame 10 has an outer projecting height equal to or less than the window trim 12, so the flat panel is fastened to the window trim 12, as depicted in FIG. 2.

A preferred transparent plastic material for the flat panel is polymethyl methacrylate (PMMA) or methyl methacrylate resin, which was first commercially available under the brand name PLEXIGLAS™ for plastic sheeting sold by Rohm and Haas Company. It is also sold under other brand names, such as LUCITE and PERSPEX. It is preferred for construction uses that benefit from its moderate properties, easy handling and processing, and low cost. The PMMA plastic sheeting may have a preferred thickness in the range of 1/16 inch to ¼ inch thick, or more preferably ⅛ inch to 3/16 inch thick, for sufficient strength and rigidity for the rain guard application. The edges of the panel may be rounded for a more aesthetic look and for safety in handling. Other types of transparent plastic sheet materials with sufficient rigidity and good weathering properties may be used.

The rain guard and wind deflector device may be used as an add-on or retrofit to any type and size of prefabricated windows. Most preferably, it may be used for sliding window units having frames made of vinyl or metal with smooth external surfaces for adhesive attachment of the flat panel. It may be used on other types of sliding windows such as aluminum-framed or wood-framed windows. The flat panel may be installed by fastening it to the smooth surface of window trim if the surfaces of the window frame do not form a good bond with double-stick tape. A preferred width for the flat panel may be in the range of at least 6 inches, to overlap the standard distance of 3 inches for the security locked position for sliding window panes, and up to about 12 inches, depending on the size of the window panes and whether the flat panel is installed on the window frame or trim. Most preferably, the flat panel has a width of 6 to 8 inches. The flat panel length may be preformed in standard lengths or cut to the window frame size that the flat panel is to have its mounting edge attached to. Most preferably, the flat panel may be preformed in standard lengths or cut to size to fit sliding window frame heights of 2 feet to 6 feet.

A preferred type of fastener for the flat panel is double-sided sticky adhesive tape which is commonly available and can be readily cut to correct length. An outwardly facing side of the double-stick tape can be applied adhesively between the mounting edge 30a and adjoining opposing linear sides 30b, 30c of the flat panel 30, and the corresponding linear sides 10a, 10b, 10c of the window frame 10, or linear sides 12a, 12b, 12c of the window trim. A standard type of prefabricated sliding window has a window frame of vinyl or metal with external surfaces ¾ inch wide. Double-stick tape in a standard width of ¾ inch width can be cut to length to form an adhesive joint between the flat panel and the window frame. Window trim or molding can be installed surrounding a window frame in various widths, with 2-inch width being most common, so standard 2-inch width double-stick tape can be used. When used with prefabricated vinyl windows that have drip vent holes in the bottom rail of the window frame, the double-stick tape is not applied over the drip vent holes to keep them open for discharging moisture from the frame outside.

For cleaning the insect screen when a rain guard panel is installed, the screen can be unclipped from its spring mount and removed to the interior of the house and/or angled and passed outward through the window opening to the side of the panel. Other types of fastening strips that allow easy detachment may be used, such as adhesive hook-and-loop fastener strips or magnetic strips for metal-framed windows. The type of fastening strip used should have sufficient holding strength to be stable under expected high rain and wind forces, but low enough that the flat panel can be forced outwards from the inside for emergency exit through the open window.

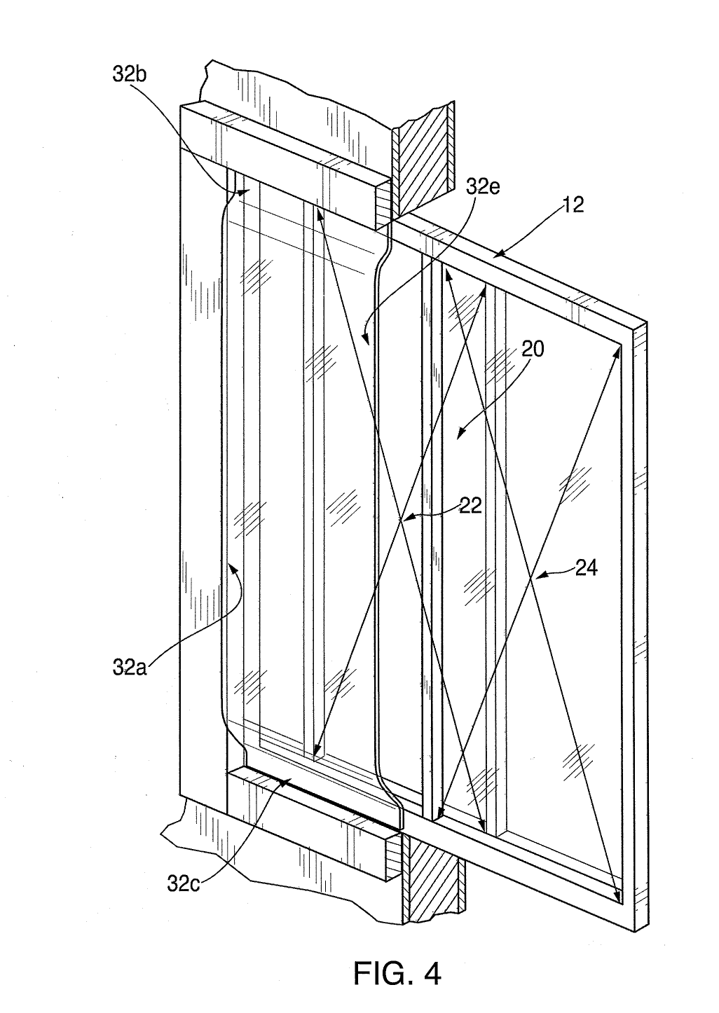

FIG. 4 illustrates another preferred embodiment of the rain guard and wind deflector device in which the flat panel 32 configured with a curved bend radius RR proximate its mounting edge 32a and adjoining opposing linear, sides 32b, 32c to form a flat panel surface 32e that is raised to a greater gap distance beyond a plane defined by the mounting edge and adjoining opposing linear sides of the flat panel. The flat panel 32 with raised surface may preferably be used where the air gap between the outer insect screen in the outer track space 25 and the external surfaces of the window frame may not be wide enough to allow the desired air ventilation through the opened window. In FIG. 3, the linear sides 32a, 32b, 32c of the flat panel 32 are shown mounted to the linear sides 10a, 10b, 10c of the window frame 10, providing a greater gap distance such as ¾ inch from a plane on the external side of the outer track space 25. If mounted to the window trim 12, the flat panel 32 with raised surface can provide an even greater air gap.

The installation in FIG. 4 is depicted in proportions for a 4 foot by 4 foot sliding glass window unit using a 12-inch wide flat panel. The ¾-inch projecting height of the raised panel surface of the flat panel 32 provides a greater gap distance from the insect screen position of 1 inch or more.

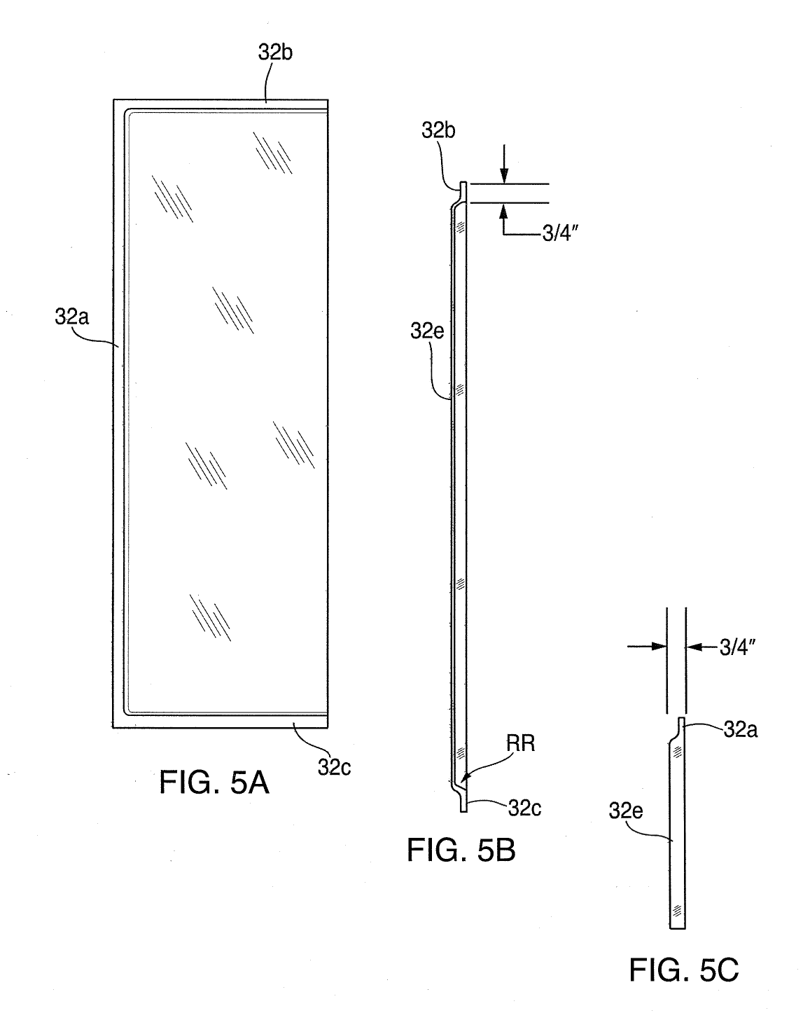

FIGS. 5A, 5B, and 5C show the flat panel 32 with raised surface 32e in front, side, and top views, respectively.

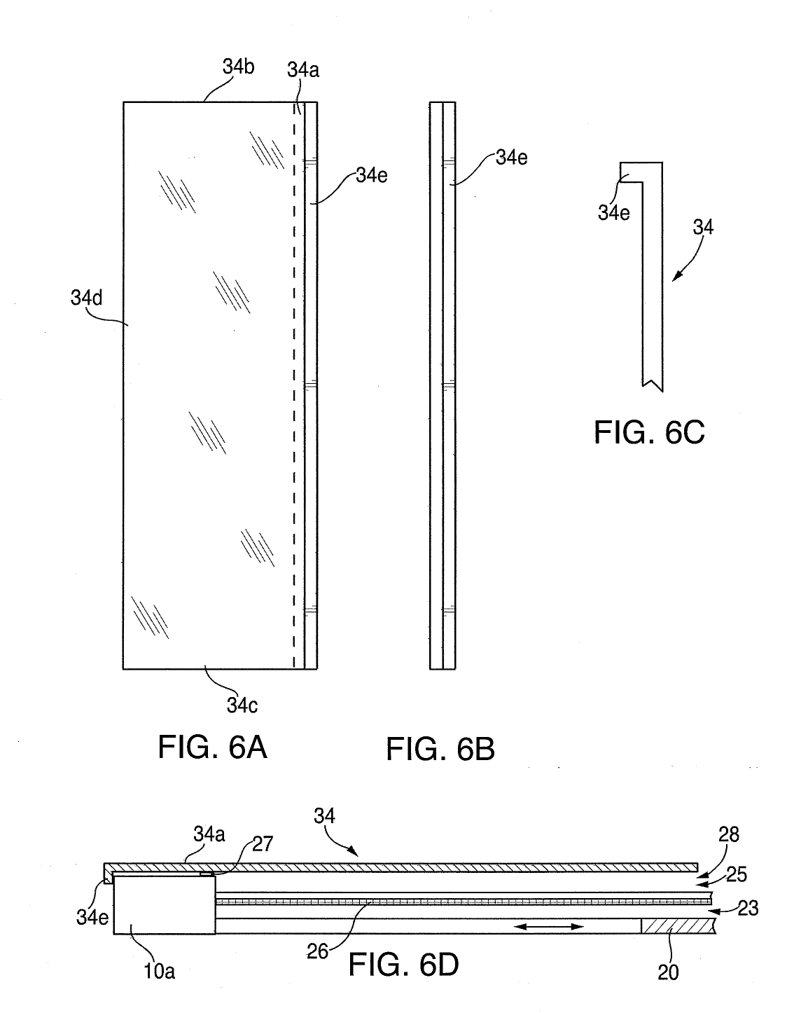

FIGS. 6A, 6B, 6C and 6D show another preferred version of the flat panel in front, side, top and enlarged assembled views, respectively. The flat panel 34 has a bead 34e formed along its mounting edge 34a which projects a small distance in a direction normal to the plane of the flat panel. The bead forms an alignment surface for abutting the linear side edge 10a of the window frame 10 (or 12a of the window trim 12), so that the flat panel can be readily aligned in correct position to the window frame or trim. For a panel having a thickness of ¼ to 3/16 inch, the bead may project about ⅛ inch to 1/16 inch from the lower plane of the panel. When using double-sided sticky adhesive tape 27, the bead 34e would cover the side of the adhesive joint between the mounting edge 34a of the flat panel 34 and the linear side 10a of the window frame (or trim) to prevent rain, dirt, or moisture from degrading the adhesive joint. The air gap 28 between the free end 34d of the flat panel and the insect screen 26 in the outer track 25 is shown relative to the slidable inner pane 20 in the inner track 23.

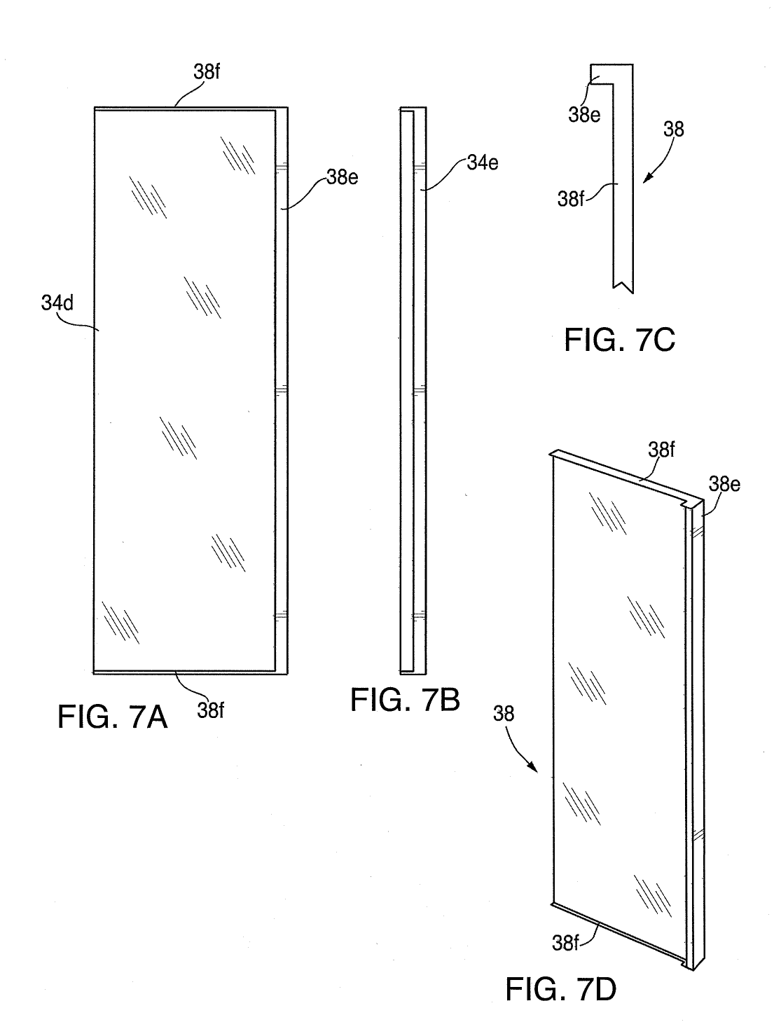

FIGS. 7A, 7B, 7C and 7D show another version of the flat panel in front, side, top and perspective views, respectively. The flat panel 38 has reinforcing strips 38f attached on the edges of its adjoining opposing linear (top and bottom) sides of the panel to stiffen the plane of the panel and its free end from deflection in strong winds. A reinforcing strip may also be attached to stiffen the free end of the panel. The reinforcing strips may be used on flat panels sized for larger sliding windows of up to 6-foot heights, in order to provide sufficient rigidity to the free end of the panel so that it does not bend or flutter in high winds. However, it may not be needed for small windows of 2-foot to 3-foot heights. The reinforcing strips may be made of the same plastic material or, if needed, a stiffer plastic material.

The above-described embodiments of the flat panel can be pie-formed in standard sizes or cut to size and installed directly on the window frame or window trim as appropriate. The flat panel is symmetric on its opposing linear sides adjoining the mounting edge for interchangeable use on left or right-handed sliding window units.

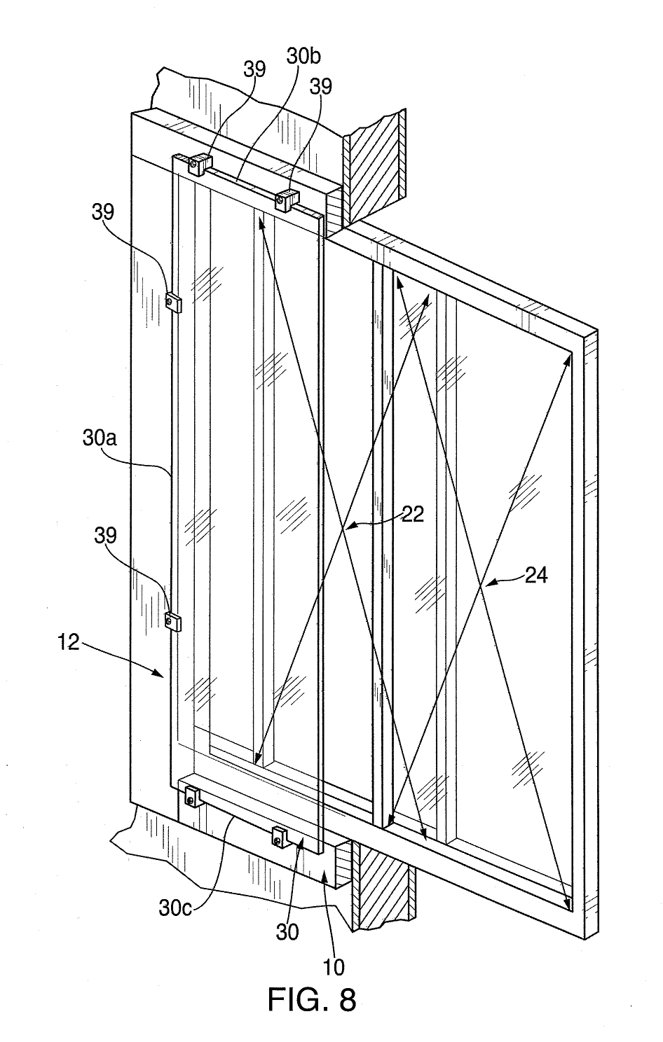

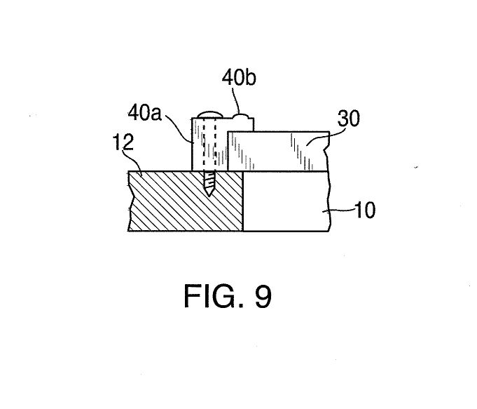

FIG. 8 shows another preferred type of fastener means is the form of a commonly available screen clip 39 mounted in pairs on each of the linear sides 30a, 30b, 30c of the flat panel 30. This type of mounting may be conveniently used when the window frame is surrounded by trim or molding of the same projecting height. As shown in greater detail in FIG. 9, the screen clip 40 has a screw mounting 40a for fastening as screw into the window trim 12, and a radial swivel tab 40b which can be swiveled in position to hold the linear sides 30a, 30b, 30c of the flat panel to the corresponding linear sides of the window frame 10. Use of the swivel screen clips also enables the user to easily remove the panel for cleaning the panel or the screen, window pane, frame or trim. Other common types of fasteners may also be used if convenient for the installer, such as screws, brackets, moldings, etc.

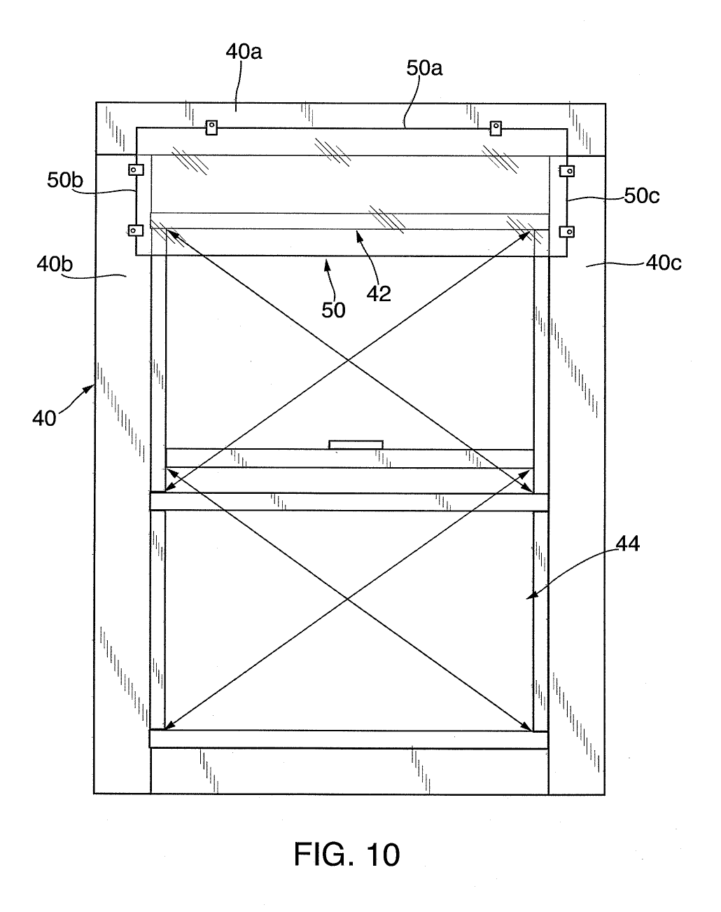

FIG. 10 shows the rain guard and wind deflector device adapted for use with other types of sliding window units. In this version, the device is adapted for use with the upper sliding pane of a double-hung window unit. The typical double-hung window unit has a window frame mounted within window trim 40, and a sliding upper pane 42, and a sliding lower pane 44 mounted for sliding movement in the frame to open the window. The mounting edge 50a of a flat panel 50 may be attached to the horizontal, upper window trim segment 40a, and its opposing vertical segments 50b, 50c attached to the opposing vertical window trim segments 40b, 40c to extend over a substantial portion of the opening of the upper pane 42 to deflect rain and wind from entering the interior.

The rain guard and wind deflector device in the present invention allows for ventilation through an opened window under rainy conditions, while deterring dampness to the interior of the house due to rain and conditions that may promote mold growth. It avoids wetting of window sills and interior furnishings which may lead to rain damage and costly repairs. The device enables continued air flow in the house even under windy conditions, while deterring contamination of the interior due to wind-blown dust and debris.

The device is made of clear plastic material of a simple construction to handle its application needs and requirements in a most convenient and low cost way. It can be sized and installed directly on the window frame or window trim as appropriate. The preferred types of fastener that may be used have sufficient strength and integrity for its application, while also allowing the flat panel to be forced out from within for emergency exit through an opened window if required. The flat panel is symmetric on its opposing linear sides adjoining its mounting edge for installation on left or right handed sliding window units. The device is readily installed without special tools using simply double-stick tape, or common types of fasteners such as screen clips, screws, brackets, or moldings, etc. The plastic flat panel may be etched or have decals adhered to it for a decorative touch.

It is to be understood that many other modifications and variations may be devised given the above description of the general principles of the invention. It is intended that all such modifications and variations be considered as within the spirit and scope of this invention, as defined in the following claims.

1. A rain guard and wind deflector device, adapted for use with a prefabricated window of the type having at least one rectangular-shaped window pane of a predetermined length and width that is slidable on one lateral side in an inner track formed in a rectangular-shaped window structure, with an insect screen mounted in an outer track space of the window structure, said device comprising:
a flat panel of transparent plastic material in a rectangular shape which is defined with a mounting edge on one linear side of its rectangular shape,
first fastener means for fastening said mounting edge of said flat panel to a corresponding linear side of the window structure,
second and third fastener means for fastening opposing linear sides adjoining said mounting edge of said flat panel to opposing linear sides adjoining the one linear side of the window structure, respectively,
wherein said mounting-edge of said flat panel has a length slightly greater than the length of the slidable window pane and a width in a direction that the window pane is slid that is a substantial portion of the width of the window pane, and
wherein outer surfaces of the linear sides of the window structure extend outwardly a slight gap distance beyond the insect screen mounted in the outer track space in the window structure, thereby leaving the slight gap distance between said flat panel and the insect screen for air-flow through the window when the window pane is slid to an opened position.

2. A rain guard and wind deflector device according to claim 1, adapted for use with a single-pane sliding window unit of the type having a slidable inner glass pane in the inner track formed in a window frame in parallel with a fixed outer pane positioned in an outer track space of the window frame, wherein said fastener means on three sides are attachable to hold said mounting edge and adjoining opposing linear sides of said flat panel to corresponding linear sides of the window frame, respectively.

3. A rain guard and wind deflector device according to claim 1, adapted for use with a single-pane or double-pane sliding window unit which has glass panes mounted within a window frame, and around which a window trim in a rectangular shape has sides to be installed surrounding corresponding sides of the window frame, wherein said fastener means on three sides are attachable to hold said mounting edge and adjoining opposing linear sides of said flat panel to corresponding linear sides of the window trim, respectively.

4. A rain guard and wind deflector device according to claim 1, wherein said flat panel has a curved bend radius proximate said mounting edge and adjoining opposing linear sides to form a flat panel surface that is raised a slight gap distance beyond a plane defined by said mounting edge and adjoining opposing linear sides of said flat panel.

5. A rain guard and wind deflector device according to claim 4, which is adapted for use with a window structure having a window frame with linear sides that are untrimmed or trimmed, wherein said fastener means on three sides are attachable to hold said mounting edge and adjoining opposing linear sides of said flat panel to corresponding linear sides of the window frame or trim, respectively.

6. A rain guard and wind deflector device according to claim 1, adapted for use with a window unit having a window frame with linear sides surrounded by corresponding linear sides of window trim, wherein said fastener means are formed as mounting means attachable to corresponding linear sides of the window trim and provided with tabs for holding said mounting edge and adjoining opposing linear sides of said flat panel to corresponding linear sides of the window frame.

7. A rain guard and wind deflector device according to claim 1, wherein said fastener means are fasteners strips having opposite inwardly and outwardly facing sides made of fastening material which is adapted for attachment on its inwardly facing side to corresponding linear sides of the window structure and on its outwardly facing side to said mounting edge and adjoining opposing linear sides of said flat panel, respectively.

8. A rain guard and wind deflector device according to claim 7, wherein said fastener means is double-sided sticky adhesive tape.

9. A rain guard and wind deflector device according to claim 1, adapted for use with sliding window units having frames made of vinyl or metal with smooth external surfaces for adhesive attachment of said flat panel.

10. A rain guard and wind deflector device according to claim 9, wherein a preferred width for said flat panel is in the range of at least 6 inches up to about 12 inches, and most preferably, a width of 8 inches.

11. A rain guard and wind deflector device according to claim 9, wherein said flat panel length is preformed in standard lengths or cut to accommodate sliding window frame heights of about 2 feet to 6 feet.

12. A rain guard and wind deflector device according to claim 1, adapted for use with single-hung windows having a frame segment for a fixed upper pane to which said mounting edge of said flat panel is attached and said flat panel is oriented to extend downwardly over a slidable lower pane for deflecting rain and wind when the lower pane is opened.

13. A rain guard and wind deflector device according to claim 1, wherein the transparent plastic material for said flat panel is polymethyl methacrylate (PMMA).

14. A rain guard and wind deflector device according to claim 13, wherein the plastic material is plastic sheeting having a preferred thickness in the range of 1/16 inch to ¼ inch thick, or more preferably ⅛ inch to 3/16 inch thick.

15. A rain guard and wind deflector device according to claim 1, wherein said flat panel of transparent plastic material has a bead formed along its one linear side which projects a small distance in a direction normal to the plane of said flat panel for alignment with an edge of the one linear side of the window structure.

16. A rain guard and wind deflector device according to claim 1, wherein said flat panel has reinforcing strips attached on edges of the linear sides of said panel to stiffen the plane of the panel and its free end from deflection in strong winds.

17. A rain guard and wind deflector device according to claim 1, adapted for use with a window structure that has window trim in a rectangular shape with sides to be installed surrounding corresponding linear sides of a window frame, wherein said fastener means is a screen clip having a screw mounting for mounting into the window trim and a radial swivel tab which can be swiveled in position to hold the linear sides of said flat panel to corresponding linear sides of the window frame.

18. A rain guard and wind deflector device according to claim 1, adapted for use with a double-hung window unit with a slidable upper pane mounted in the window structure, wherein the mounting edge and opposing linear sides of said flat panel is attached to an upper horizontal segment and opposing vertical segments of the window structure, respectively, and said flat panel is oriented to extend downward over an opening of the slidable upper pane for allowing air to flow in under the free end of said flat panel when the upper pane is opened.

19. A rain guard and wind deflector device according to claim 1, adapted for use with prefabricated windows of a type from the group consisting of: sliding window units; single-hung window units; vinyl-framed window units; metal-framed window units; and wood-framed window units.

20. A rain guard and wind deflector device according to claim 1, wherein said fastener means is of a type from the group consisting of: double-stick tape; screen clips; hook-and-loop fastener strips; magnetic strips; screws; brackets; and moldings.
